(19) United States
(12) Patent Application Publication
(10) Pub. No.: US 2004/0258241 A1
(43) Pub. Date: Dec. 23, 2004

(54) Processing method and device for image encryption and decryption

(76) Inventors: Chien-Liang Chang, Banchiau City (TW); Shun-Yi Liao, Shinjuang City (TW)

Correspondence Address: BIRCH STEWART KOLASCH & BIRCH, PO BOX 747, FALLS CHURCH, VA, 22040-0747, US

(21) Appl. No.: 10/600,508

(22) Filed: Jun. 23, 2003

(51) Int. Cl. H04N 7/167

(52) U.S. Cl. 380/200

(57) ABSTRACT

The invention discloses a processing method and device for image encryption and decryption. The processing method is first to obtain at least one main film and at least one subsidiary film. Then, when the at least one main film and the at least one subsidiary film are playing, the video signals will be synchronously inputted into the composite video-signal processing unit for processing composite video signals. Next, when the video signals of the at least one main film and at least one subsidiary film are executing the composite video signal process, a markup signal is added into each field of the main film synchronously. Thus, an encrypted composite film is completed. In addition, after the analog video signal in the encrypted composite film has been converted into a digital video signal output through the analog/digital converter, the digital video signal output will be stored in the memory unit. Then, the detection control unit will determine whether the data in the memory should be updated. Finally, the data in the memory will be sequentially outputted to the digital/analog converter continuously so that the digital data stream can be converted into analog video signal output, and thus the viewer can watch the main film.

### FIELD OF THE INVENTION

The invention relates to a processing method and device for image encryption and decryption and, more particularly, to adding encryption to a film so that when video signals are outputted without executing a decryption process, the image that can be viewed by a viewer is only an overlap of multiple video signals, which can prevent a non-adult from watching an R-rated film.

### BACKGROUND OF THE INVENTION

Nowadays, it is very convenient for everybody to watch a videotape or videodisk because video signals are loaded in the videotape or videodisk. As soon as a videotape or videodisk is playing in a playing device, the loaded-in video signals are ready to be viewed.

However, rating is essential to all the videotapes and videodisks in order to prevent youngsters from viewing inadequate films. In general, films or movies are categorized into four different ratings: general audiences (G), parental guidance suggested (PG), parents strongly cautioned (PG-13), and restricted (R). Among them, the R-rated films are considered most difficult to be regulated because despite the rating system, they are still available in merchandise stores or rental stores.

Therefore, to cope with the problem caused by the R-rated films, some filmmakers apply a Mosaic processing method to the video signals played in a film. The theory of Mosaic is to implement Mosaic signals on the images that are improper to be viewed. For instance, an obscene image can be processed by pixellation. After the process, the pixels of the image will become larger, and the image is similar to one being looked through a Mosaic window. The process of pixellation is first to add up gray levels of all the pixels in the mask and obtain their average. Then, the average value will be rewritten into the gray level of each pixel in the mask. Thus, the improper portion of an image (such as tough violence or nudity) will become vague and cannot be clearly watched.

However, although adding Mosaic signals into playing video signals may achieve image encryption, the image resolution after encryption cannot be increased; in turn, the color vision effect may become worse. Moreover, despite that the cost of making Mosaic signals is very high and that the technique itself can only provide an image unable to be clearly watched, the unclear playing image, however, can still remain on the screen, which means the image cannot be fully blocked. As a result, an adolescent, for instance, may still have a chance to fantasize about the contents of an obscene film. Worse still, a device for decoding Mosaic signals can be bought from stores to decode the film for viewing. Therefore, encryption through Mosaic signals is not an ideal method to prevent the non-adults from viewing R-rated films.

### SUMMARY OF THE INVENTION

To solve the aforementioned problem caused by the Mosaic technique, the object of the invention is to add video signals into a film so that when the film is playing but not executing the process of decoding, the video signals of the playing film cannot be watched; in other words, the playing video signals can only be seen when the decoding process is executed.

### BRIEF DESCRIPTION OF THE DRAWINGS

FIG. 1 is a flow chart showing the processing method of image encryption of the invention.

FIG. 2 is a schematic diagram showing the processing method of encryption for image field of FIG. 1.

FIG. 3 is block schematic diagram showing the circuits of image decryption of the invention.

FIG. 4 is a flow chart showing the processing flow of image decryption of the invention.

### DETAILED DESCRIPTION OF THE PREFERRED EMBODIMENTS

The object and technical contents of the invention will be better understood through the description of the following embodiment with reference to the drawings.

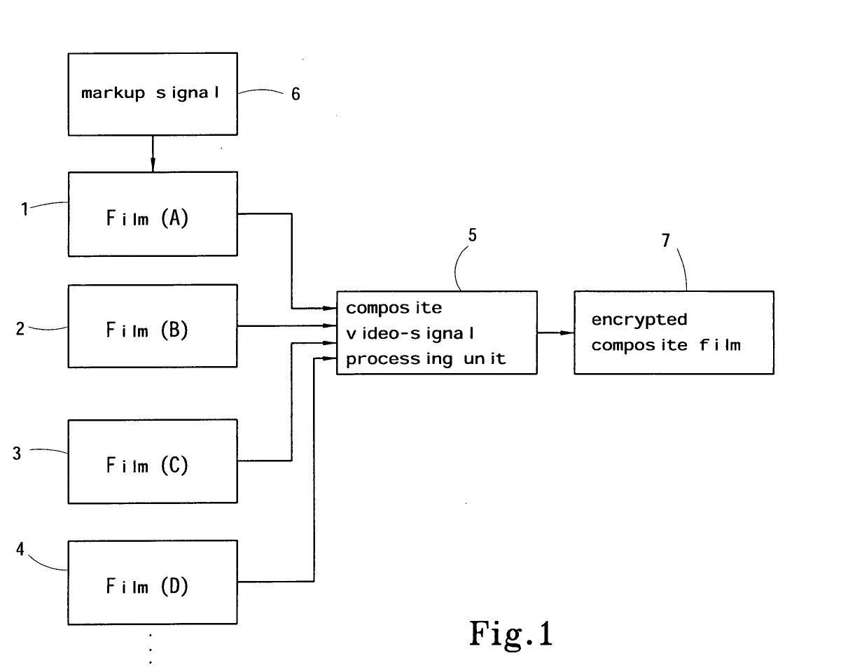

FIG. 1 is a flow chart showing the processing method of image encryption of the invention. As shown in FIG. 1, an image encryption and decryption processing method and device according to the invention is to add a markup signal (a password) into the video signals of a film, and when the film is playing but not decoding the markup signal, the video signals perceived by the viewer is a composite video signal that is an overlay of multiple video signals; that is, the viewer cannot see the actual on-going video signals. Therefore, an R-rated film can be blocked and not to be watched by a non-adult. In the same way, the business confidential information can be prevented from being stolen by applying the same method.

To approach the method for image encryption, the first step is to execute a process of selecting films, which is to select at least one main film 1 and at least one subsidiary film, such as films 2, 3 & 4. When the main film 1 and subsidiary films 2, 3 & 4 are playing, the video signals will be inputted into the composite video-signal processing unit 5.

The second step is to execute the process of image composition, which is to synthesize and overlap the video signals in the composite video-signal processing unit 5 after the video signals of the main film 1 and subsidiary films 2, 3 & 4 have been synchronously inputted into the composite video-signal processing unit 5. Meanwhile, in the process of composition, a markup signal 6 will be synchronously added into each field of the main film 1, and then a composite film 7 with encryption is completed.

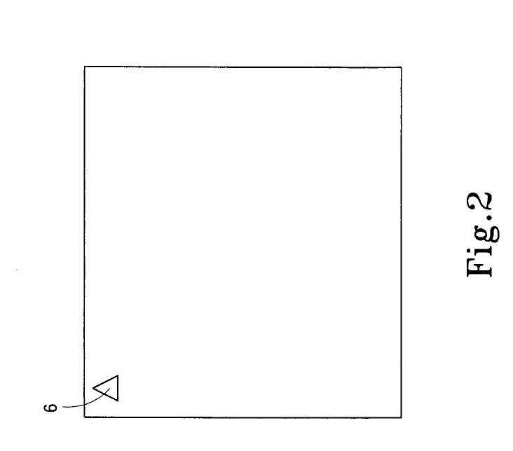

Also, FIG. 2 is a schematic diagram showing the processing method of encryption for image field of FIG. 1. As shown in FIG. 2, during the composite process for video signals of main film 1 and subsidiary films 2, 3 & 4, the markup signal 6 that has been added into each field of the main film 1 is composed of a pattern located by a horizontal synchronous signal and a vertical synchronous signal. When the film is playing in the playing device and the playing device (not shown) has detected a reading of markup signal 6, the playing device will only read the video signal that contain the markup signal 6. Meanwhile, the image displayed by the playing device (not shown) will contain video signals that have markup signals 6, not an image with multiple overlapping signals. Conversely, if the playing device (not shown) does not contain such decoding device, the image being viewed is an overlap of multiple video signals.

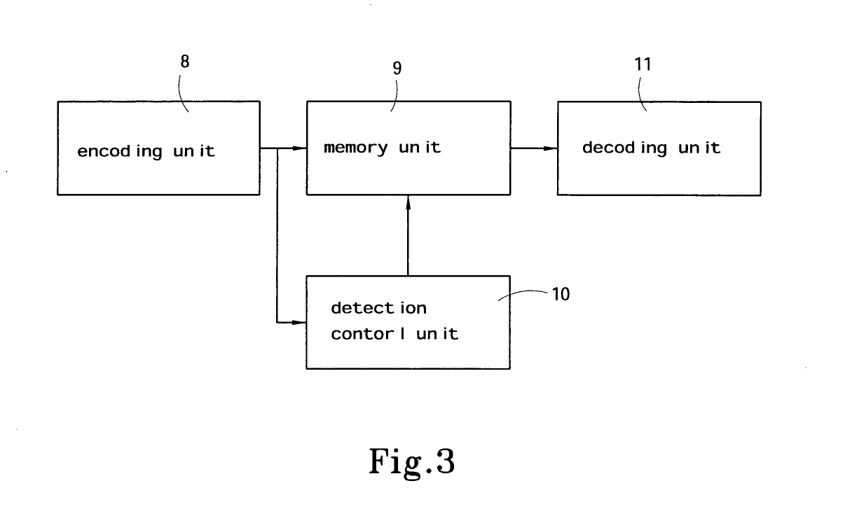

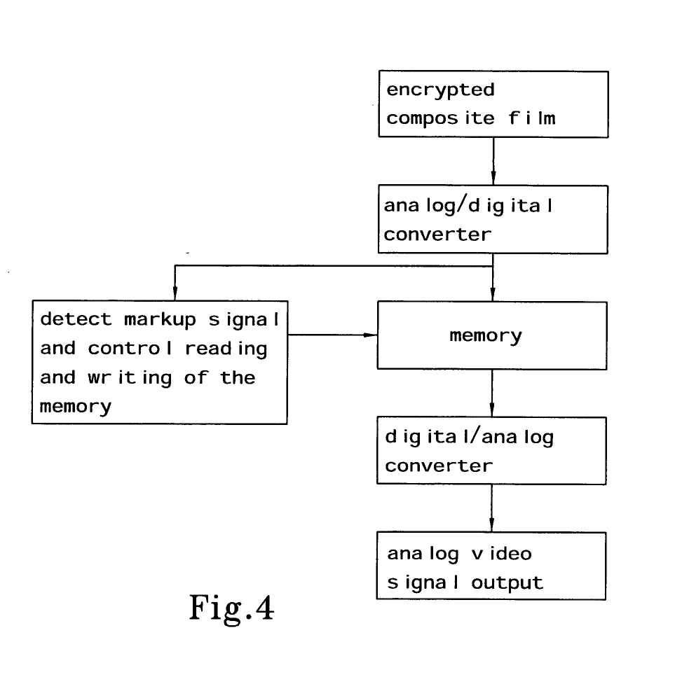

FIG. 3 is block schematic diagram showing the circuits of image decryption of the invention, whereas FIG. 4 is a flow chart showing the processing flow of image decryption of the invention. As shown in FIGS. 3 & 4, when an encrypted composite film is playing, an image decryption device has to be employed for decrypting an image. The image decryption device includes an encoding unit 8, a memory unit 9, a detection control unit 10, and a decoding unit 11. The function of each component of image decryption device will be described as below:

a) The encoding unit 8 is an analog/digital converter for converting an analog video signal in an encrypted composite film into a digital video signal output.

b) The memory unit 9 is a dual-port memory for storing digital video signals outputted by the encoding unit 8.

c) The detection control unit 10 is for detecting the markup signal 6 and controlling the reading and writing of memory so as to determine whether the data in the memory unit 9 should be updated.

d) The decoding unit 11 is a digital/analog converter for converting the digital image data stream outputted by the memory unit 9 into an analog video signal output.

When an analog video signal in the encrypted composite film has been converted into a digital video signal output through the analog/digital converter, the digital video signal output will be stored in the memory unit 9, and then the detection control unit 10 will determine whether the data in the memory should be updated. The procedures of decision-making are described as follows:

1) Step one: the horizontal synchronous signal and the vertical synchronous signal of an image will locate the position of the markup signal.

2) Step two: each sample value of a sampling signal will be compared with that of another sampling signal in the position of markup signal.

3) Step three: if a sample value is larger than a compared value, then the inner accumulator increases one.

4) Step four: if the inner accumulator is larger than a preset value, then the data in the memory should be updated; conversely, if the inner accumulator is smaller than the preset value, then the data should not be updated.

Meanwhile, in the application, data reading is not being controlled; instead, data in the memory is being sequentially outputted to the digital/analog converter continuously so that the digital data stream can be converted into analog video signal output, and thus the viewer can watch the main film.

Moreover, other than being applied in an R-rated film, the processing method for image encryption of the invention can also be applied to commercial films photographed by business companies. Therefore, business confidential information can be prevented from being divulged or stolen.

Furthermore, the processing method and device for image encryption and decryption can also be installed inside a monitor. Thus, when a cable TV station or non-cable TV station is playing an R-rated program, the viewer cannot watch the program if the method of decryption and its relative device are not available.

What is claimed is:

1. A processing method for image encryption, which is to add encryption to a main film, including the following procedures:
a) at least one main film and at least one subsidiary film are obtained;
b) when the at least one main film and the at least one subsidiary film are playing, the video signals will be synchronously inputted into the composite video-signal processing unit for processing composite video signals;
c) when the video signals of the at least one main film and the at least one subsidiary film are executing the composite video signal process, a markup signal is added into each field of the main film synchronously, and then an encrypted composite film is completed.

2. The processing method for image encryption as claimed in claim 1, wherein the composite video-signal processing unit is to synthesize the video signals of the at least one main film and the at least one subsidiary film by overlapping the video signals.

3. The processing method for image encryption as claimed in claim 1, wherein the markup signal is a synchronous signal.

4. The processing method for image encryption as claimed in claim 3, wherein the synchronous signal is composed of a horizontal synchronous signal and a vertical synchronous signal.

5. The processing method for image encryption as claimed in claim 4, wherein the pattern of markup signal is located by the horizontal synchronous signal and the vertical synchronous signal.

6. An image decryption device, which is to perform a process of decryption for an encrypted composite film playing in a playing device, wherein the image decryption device includes:
an encoding unit, for executing an encoding process for the encrypted image;
a memory unit, for storing digital signals that have been done with encoding;
a detection control unit, for detecting the markup signal and controlling the reading and writing of the memory so as to determine whether data in the memory unit should be updated; and
a decoding unit, for converting the digital image data stream outputted by the memory unit into an analog video signal output.

7. The image decryption device as claimed in claim 6, wherein the encoding unit is an analog/digital converter.

8. The image decryption device as claimed in claim 6, wherein the memory unit is a dual-port memory.

9. The image decryption device as claimed in claim 6, wherein the decoding unit is a digital/analog converter.

10. A processing method for image decryption, which is to perform a process of decryption for an encrypted composite film that is playing in a playing device, wherein the processing method for image decryption includes:
a) the digital video signal output will be stored in the memory unit after an analog video signal in the encrypted composite film has been converted into a digital video signal output through the analog/digital converter;
b) the detection control unit will determine whether the data in the memory should be updated;
c) the data in the memory will be sequentially outputted to the digital/analog converter continuously so that the digital data stream can be converted into analog video signal output, and thus the viewer can watch the main film.

11. The processing method for image decryption as claimed in claim 10, wherein the procedures of determining whether the data inside the memory should be updated are listed as below:
step one: the position of the markup signal is located by the horizontal synchronous signal and the vertical synchronous signal of an image;
step two: each sample value of a sampling signal will be compared with that of another sampling signal in the position of markup signal;
step three: if a sample value is larger than a compared value, then the inner accumulator increases one;
step four: if the inner accumulator is larger than a preset value, then the data in the memory should be updated; conversely, if the inner accumulator is smaller than the preset value, then the data should not be updated.
